(19) United States
(12) Patent Application Publication
(10) Pub. No.: US 2003/0140224 A1
(43) Pub. Date: Jul. 24, 2003

(54) Procedure and system for transmission of data

(75) Inventor: Harri Vatanen, Sunningdale (GB)

Correspondence Address: COHEN, PONTANI, LIEBERMAN & PAVANE, 551 FIFTH AVENUE, SUITE 1210, NEW YORK, NY, 10176, US

(73) Assignee: Sonera Oyj

(21) Appl. No.: 10/328,390

(22) Filed: Dec. 23, 2002

Related U.S. Application Data
(63) Continuation of application No. PCT/FI01/00596, filed on Jun. 21, 2001.

(30) Foreign Application Priority Data
Jun. 21, 2000 (FI) 20001488

(51) Int. Cl. H04L 9/00

(52) U.S. Cl. 713/153

(57) ABSTRACT

A method and system for the handling of a transaction request sent to a server from a terminal device over a telecommunication network, where the transaction request includes identifying data of the requester, identifying data of a utilized network component, and the digital signature of the requester. In response to the transaction request, a transaction message is sent from the server to the terminal device and/or to identified utilized network component. Message-type data and subscriber data are appended to the transaction message before it is sent by the server. The appended message-type data and subscriber data are then extracted from the transaction message in the telecommunication network and are used as handling data for carrying out and otherwise in connection with the transaction.

### CROSS-REFERENCE TO RELATED APPLICATION

This is a continuation of International Application No. PCT/F101/00596, filed Jun. 21, 2001.

### BACKGROUND OF THE INVENTION

1. Field of the Invention

The present invention is generally related to telecommunications. The invention is more particularly directed to a method and system for the transfer and routing of data, wherein the data includes identification of the service requester and of the parties involved or associated with the service provider and the service accessed or available via a telecommunication system.

2. Description of Related Art

There are currently many different kinds of mobile terminals and, with the continuing development of technology, the features and services available through wireless terminals will continue to multiply and develop. The initiation or establishment of a wireless connection from a mobile terminal to a server, payment terminal or other like device or system enables use of the mobile terminal to exploit all manner of services and data accessible via an associated telecommunication network. Additional applications and services can be made available and will continue to be developed for circumstances in which the wireless connection is established in a secure manner and where the wireless terminal user can be locally authenticated, thereby enabling secure use of wireless terminals for subscribing to products and services, for effecting payment for products and services, and for verifying the identity of parties to such product and service deliveries and transactions.

A group of the world's leading data communications and information technology companies have developed and standardized on a technique for effecting and accommodating wireless connections between, by way of example, a mobile phone and a portable computer. Such connections can moreover likewise be established between any two devices, particularly (although not exclusively) where one of the devices is a mobile terminal. This so-called “Bluetooth” technique or protocol is based on short range radio technology which enables communication connections between a wide variety of terminal devices; detailed information and specifications concerning the Bluetooth protocol and techniques can for example be found at the website www.bluetooth.com.

Bluetooth technology thus enables the connection of devices, such as a mobile station or other terminal device and a portable computer, to one other using a short-range radio link without the need to provide or rely on potentially troublesome wiring. Printers, workstations, fax machines or terminals, keyboards and virtually any other digital device can be part of a Bluetooth system or network. Bluetooth technology can accordingly be employed to form a universal bridge to existing data networks and accessories, and enables the ready formation of small private groups via devices linked to each other without a fixed network infrastructure. Encryption and authentication can be employed between the Bluetooth-connected devices, as for example so that only a particular user's mobile phone or other portable terminal can be operatively utilized with a particular portable computer or other workstation. Moreover, through the use of Bluetooth networking or connections a mobile communicator or wireless terminal can be arranged for controlling virtually any target device.

The use of a mobile communicator to carry out a variety of purchase and product or service guidance or assistance transactions is known; such transactions may for example involve the selection of a product or service and the tendering of payment using a mobile communicator via a wireless connection to an automated device. Anticipated increases in the type and number of remotely available or accessible services will provide many new and enhanced opportunities, but will also often necessitate that transmitted information and data remain between only the sender and receiver. It must therefore be possible to secure the transmitted information, as through the use of encryption.

In the use of mobile communication devices the location in or from which the information relating to a purchase or guidance transaction must be communicated is different from the location of or from which the transaction is effected or initiated or carried out. This raises a number of important requirements, one of which is that the transfer of data concerning the transaction into the central system must be effected as easily and securely as possible. In addition, the recipient of transmitted data must be able to positively verify the authenticity of the data and the identity of the sender.

Common problems currently experienced are the lack of ability to assure that transaction-related information is transmitted in the proper form and an inability of the receiving terminal to positively identify and correctly process the transmitted data. In addition, current implementations fail to assure secure transmission and routing of transaction-related data between the various different parties involved in the transaction.

The MIME (Multipurpose Internet Mail Extensions) protocol type—herein referred to as the MIME-type—defines for the terminal or browser the kind or format of a file or message obtained from a server. The server attaches the files to be transmitted to type-identifying MIME heading data which is arranged to precede the transmitted data documents. In one application, the server determines the MIME-type from the file's terminal, which it then compares to a MIME-type chart. Based on that comparison and the information in the chart, the browser attempts to determine or identify a program with which the file in question can be opened. Thus, by way of example, if the file type is determined to be “text/html”, the browser may recognize that it can itself open the file directly; if on the other hand the file type is identified as “application/zip”, then the browser must utilize another program that is capable of handling that type of file. In some cases, additional input may be requested as to whether the file should be opened or, alternatively, locally stored on a hard drive or other storage device. If the type of the file is not recognized, an attempt may be made to save the file to the hard drive of the local computer.

### OBJECTS AND SUMMARY OF THE INVENTION

It is accordingly the desideratum of the present invention to eliminate, or at least significantly alleviate, the problems and deficiencies of prior art methods, systems and apparatus, as for example as discussed hereinabove, for initiating and carrying out service transactions and the like using a wireless communications device via a telecommunications system or network.

It is a particular object of the invention to provide a method and system by which a terminal, such as a server, mobile communicator or other wireless terminal or device, can both verify and recognize the form, content and, optionally, the transmission protocol of data that is or to be sent and received in the conduct or implementation of a transaction. Moreover, in accordance with the invention a service request can be securely routed to a service provider. The present invention thus provides an advantageous solution to the difficulties and drawbacks in heretofore known methods and systems for effecting global transaction data transmission between a server and a user terminal device.

The invention is broadly related to the transmission and billing of messages in a telecommunications network. When a service requester requests (by way of example) a service, or that identified video, music or other digital data be sent over the network, messages concerning the transactions of that particular service requester are labeled. This labeling facilitates the handling and allocation of billing to the proper service requester, and are employed to assure that the service requests are properly directed and billed. As used herein, the terms “transaction” and “transaction message” are intended to generally denote a subscription, service, payment transaction, account inquiry or any electronic service or transaction that may or to be carried out through data transfer or communication equipment.

The invention is more particularly directed to a method for handling a transaction message in a telecommunications network. The telecommunications network can by way of illustrative example be a telephone network, an internet-based network, a Bluetooth-based network, a local area network, or any network defined or created by combining any combination thereof. In accordance with the inventive method, a transaction request, such as a service request, is sent from the requesting terminal to the server. The request may for example comprise data of the requester, data of the employed network component, and the digital signature of the requester. The server may be any service provider device that has a connection to other parts of the network, such as a server computer. The network component and the network component data are the receiving terminal, and its address, which the requester wishes to receive the messages for the transaction to be mediated. The digital signature accomplishes non-repudiation, i.e. confirmation or verification of the requester's request.

In response to the transaction request, a transaction message is sent from the server to the identified terminal or network component. Thus, the identified network component can also be a terminal or device other than the one from which the request was sent; the requester can make the request from the requester's mobile phone, but indicate in the request that the service is to be delivered to an identified network component other than that mobile phone. The terminal or device can accordingly be a mobile phone, desktop computer, pocket computer or any other kind of terminal or device that can form a connection to the server.

In accordance with the invention, the data or transaction message to be sent in response to the transaction request will be combined with data identifying the type of message and with requester data before it is transmitted. The message-type data comprises at least information on the data content of the message, i.e. to indicate or identify to the receiving terminal how and with which program to handle the received data. The requester data is an unambiguous identifier of the server or the transaction requester, on the basis of which applicable billing for the transaction messages can be allocated to the proper requester. The requester data may also enable identification, as from a routing chart, of a reserved fixed or dynamic network address to or of the requester to which transaction messages should be routed.

The message is mediated to the service requester on the basis of the network address, which may be an IP (Internet Protocol) address in an internet-based network or a like address. The IP address does not primarily define the receiving machine but, rather, a particular connection interface which may be located anywhere in the world. The data communications network can thus, by way of illustrative example, be the internet or another geographically-dispersed wide-area network, or the payment network of a bank.

The message-type data and the requester data are in accordance with the invention extracted from the associated transaction message in the data communications network and are used as handling data for the transaction. In one application, the extracted message-type data and requester data from each transaction message are saved in the billing database.

In some implementations, the message-type data and the requester data are attached to the header portion of the transaction message. The MIME- type can in such cases be employed to indicate to the receiving terminal or other network components which applications can handle the type of attached mediated message or files. The MIME protocol may for example be that defined by internet RFCs 2045, 2046, 2047, 2048 and 2049, although other known standards or RFCs may also or alternatively be employed as a general matter of design choice.

In a contemplated embodiment of the invention, a data link is formed between the terminal and the server. The formed data link is employed to log on to the server by using the terminal user's identity. The physical network address of the terminal and/or of a third device, to which the transaction message is to be sent, is thereafter identified or announced. The terminal's network address may also be determined by means of a unique identifier obtained in connection with the log-on process. The data link can be a connection based on Bluetooth technology, infrared, the WAP-protocol or one formed using the HTML protocol. One particular advantage in using these different ways of connecting is that they are predefined for MIME-type message transfer, so that the message-type data can readily be added, using MIME, to the message to be sent. In some applications, the messages between the terminal and server can also be transmitted as short messages.

WAP (Wireless Application Protocol) defines a standard for applications that offer services for terminal devices of a wireless network. With WAP a user may for example connect to a World Wide Web (WWW) browser via a telephone connection. Wireless Markeup Language (WAP), a descriptive language similar to HTML (Hyper-Text Markup Language) but modulated for a wireless environment, is commonly used in implementing WAP connections and communications.

In some applications or embodiments of the invention, the message sent from the terminal device may be encrypted with a service- and/or server-specific encryption key. Such encryption assures the reliability, security and authenticity of transmitted data. A message confirming receipt of a transaction message or request may also be sent from the server to the terminal device. In this manner the terminal device user is provided with confirmation of the successful transmission and receipt of, for example, a subscription where the user has subscribed a service to some other network component. The well-known public and secret keypair encryption method, typically denoted PKI (Public Key Infrastructure), can be employed for effecting encryption of the data link. The encryption of incoming and subsequent messages, and the storage and/or processing of the encryption keys, may advantageously be handled or carried out by or through a special security module, thereby enabling the ready addition of encryption and authentication of messages functionality to devices that originally did not have or incorporate such capabilities. One example of such a security module is described in published International Application No. PCT/FI99/00713.

The present invention is additionally directed to a system for the handling of transaction data in a telecommunications network. The inventive system comprises a server, which can be a computer, that carries out or implements a particular action or task directed by or initiated in response to requests from other computers or servers connected to the same network. The inventive system further comprises a terminal for forming and sending a digital signature of the transaction requester and a transaction request comprised of data of the requester and data of the employed network component. The server includes means for forming and sending a transaction message in response to a received transaction request from the terminal device.

The system additionally includes an adder or like device for appending messagetype data and subscriber data to the transaction message. A filter or the like is incorporated in or associated with the data communications network for extracting the message-type data and the subscriber data from the transaction message. A handling device is arranged to use the extracted message-type data and subscriber data for processing the request identified by the transaction message. In preferred forms of the invention the adder is implemented so as to attach the message-type data and subscriber data to or as a header, or in a header part, of the transaction message.

In an implementation of the inventive system, a collector may also be provided for collecting the extracted message-type data and subscriber data and storing the extracted data in the billing database.

The inventive system may further include means for creating a data link between the identified terminal and the identified server, and the terminal may include registration means for registering, with the identified server, the terminal user identity and the physical network address of the terminal and/or other network-accessible device to which the identified transaction message is to be sent or with which it is to be associated.

The present invention provides a number of important advantages. In particular, a terminal such as a service, mobile communicator or other wireless terminal both verifies and recognizes the form, content and, optionally, the mediation protocol of sent and received data. Moreover, the ability to bill for services and mediated data on the data communications network is notably simplified over heretofore-utilized processes. The invention additionally solves the problems inherent in current insecure global communications between servers and user terminals.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a block diagram of a system for handling transaction messages in accordance with the present invention;

FIG. 2 is a flow chart of a method for handling transaction messages in accordance with the invention; and

FIG. 3 depicts the form of a transaction message in accordance with the invention.

### DETAILED DESCRIPTION OF THE CURRENTLY PREFERRED EMBODIMENTS

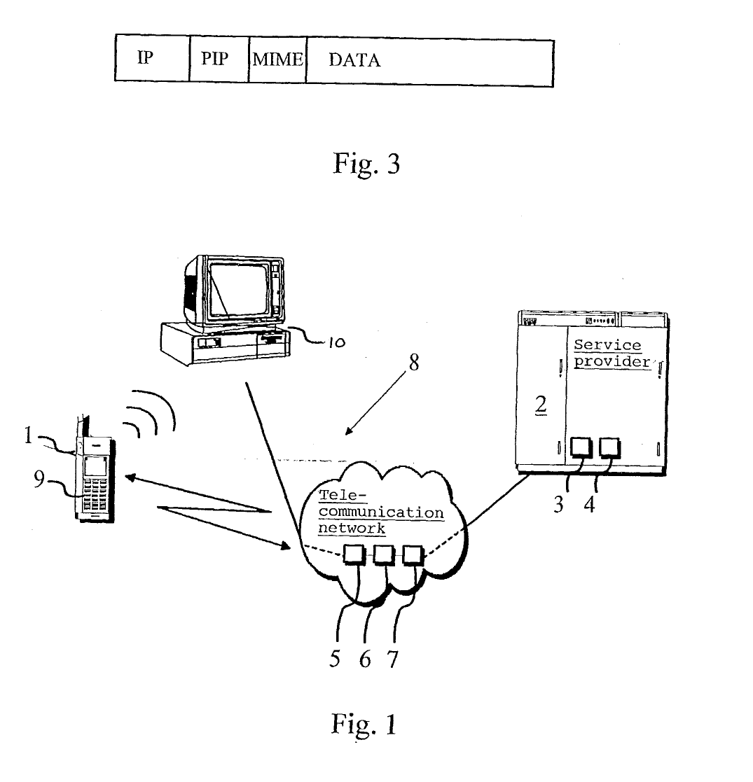

The system of FIG. 1 for the handling of transaction messages includes a server 2 which is connected to a telecommunications network and, through the network, to a terminal device 1. The terminal device 1 in the FIG. 1 system implementation and by way of illustrative example comprises a mobile phone of a user, but may alternatively be any other communications or terminal device with which transaction-related requests and messages can be sent and/or received. The terminal generates a transaction request which comprises data of the requester, an identification of the utilized network component, and the requester's digital signature. The server 2 includes means for generating and sending a transaction message in response to a transaction request received by the server from terminal device 1.

The system additionally includes an adder 4 operable for attaching or associating message-type data and subscriber data to a transaction message. The adder may for example be implemented as a program block or module or program component that operates under the guidance and control of a mainframe computer or other central processor of the server.

In the system of FIG. 1, and by way of illustrative example, the server 2 is a content provider such as one operated and controlled by or on behalf of a bank. The telecommunications or data communications network includes or incorporates a filter 5 for extracting message-type data and subscriber data from the transaction message, and a handling device 6 which is configured or otherwise operable to use the extracted message-type data and subscriber data as the handling data for the subject transaction. The filter 5 and/or handling device 6 may for example be implemented as program blocks or modules or program components of the telecommunications network, as in an interface to the billing system.

The system of FIG. 1 still further includes a collector 7 for collecting the message-type data and the subscriber data that is extracted from each transaction message and for storing the extracted and collected data in the billing database. The collector thus receives the data of mediated transaction messages from the filter 5 and/or the handling device 6 for billing and other post-processing operations and functionality.

Also included in the system of FIG. 1 is a means 8 for implementing or creating a data link between the terminal device 1 and the server 2. The means 8 may and will generally comprise those components typically necessary and/or employed in a telecommunication network, such as mobile phone network components, to form a communications connection between a terminal device 1 and a server 2 using, for example, the WAP protocol.

The terminal device 1 includes registering means 9 operable for registering the terminal with the server 2 using the terminal user identity and by announcing the physical network address, for example the IP-address of the terminal 1 and/or of another device such as a PC (personal computer) 10, to which the requested subject matter and/or notifications or the like relating to the transaction message is to be sent.

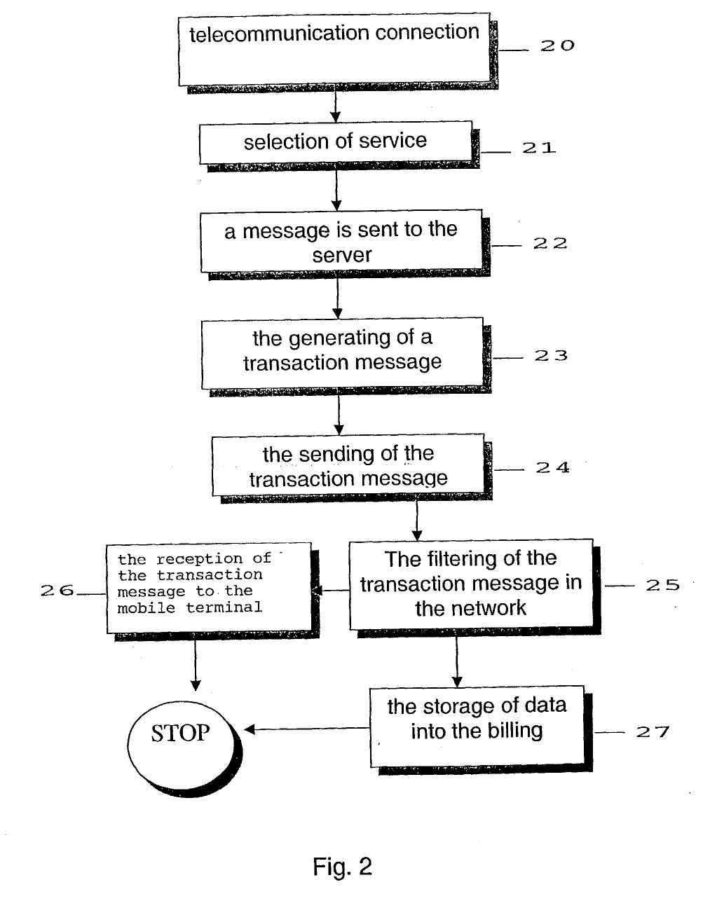

A method of handling transaction messages in accordance with the invention is illustrated in the flowchart of FIG. 2. At block 20, a data link is formed from terminal device 1 to server 2. The data link may, by way of example, comprise a connection formed using the WAP protocol over a mobile telephone network. With the data link in place, the customer can proceed to choose a desired service from a service menu presented by the server (block 21) and enter the necessary parameters, i.e. data of the requester, the address of the utilized network component, and the digital signature of the requester. The selection and parameter data is then sent to the server (block 22).

The service may for example be a request for payment of a bill through the bank or an order for a rental video to be delivered via the set top box of the customer. Where necessary or appropriate, encryption of the connection can be effected through the telecommunications connection. When all of the data needed for the requested service has been acquired from the terminal device, the actual operations for effecting or implementing the requested service are carried out, i.e. generating of the transaction message or messages, which depending on the particular service may be one or a multiplicity of messages (block 23). After the transaction message has been generated, it is sent (block 24) to the network address entered or identified by the terminal for the utilized network component, such for example as the network address of the terminal device 1 or of the PC 10.

The transaction message is filtered in the data communications network, whereby the data required for billing and other subsequent or post-transaction handling of the message is collected through extraction from the transaction message (block 25). After such filtering, the transaction message is forwarded to the terminal device 1 (block 26), and the collected data is stored in a billing system or the like (block 27).

FIG. 3 depicts by way of illustrative example a transaction message implementation arranged in accordance with the invention. At the beginning of the message is an address part IP which indicates the physical network address of the terminal. Following the address part IP is a subscriber data part PIP which indicates the subscriber's individual identifier or personal IP address; in some cases, the subscriber's identifier and personal IP address may be the same. The third or next part is the message-type MIME which identifies, for the receiving network component, the content of the message to enable the receiving component to handle the message on the basis of the identified message-type. The final part of the transaction message is the actual data part DATA, which can contain the digital signature and which may be encrypted. The content of the data part generally otherwise depends on the particular requested service which is the subject of the transaction message.

While there have been shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for handling transaction data in a telecommunications network in which a transaction request is sent to a server from a terminal device of a requester, the transaction request comprising identifying data of the requester, identifying data of a utilized network component and a digital signature of the requester, and wherein a transaction message is sent from the server to one of the terminal device and the identified network component in response to the transaction request, said method comprising the steps of:
attaching to the transaction message, prior to said sending of the transaction message from the server to one of the terminal device and the network component, message-type data and subscriber data;
collecting, in the telecommunications network, the message-type data and the subscriber data from the sent transaction message; and
using the collected message-type data and subscriber data as handling data for a transaction that is the subject of the transaction request.

2. A method in accordance with claim 1, where said collecting step comprises collecting the message-type data and the subscriber data in a billing database.

3. A method in accordance with claim 1, wherein said attaching step comprises attaching the message-type data and the subscriber data to a header part of the transaction message.

4. A method in accordance with claim 1, further comprising the steps of:
forming a data link between the terminal device and the server;
registering the terminal device with the server using a user identity of the terminal device; and
declaring a physical network address of one of the terminal device and another device to which the transaction message is to be sent.

5. A method in accordance with claim 1, further comprising the step of encrypting the transaction request to be sent from the terminal device to the server with one of a service-specific encryption key and a server-specific encryption key.

6. A method in accordance with claim 1, further comprising the step of sending a confirmation message from the server to the terminal device in response to receipt of the transaction message.

7. A method in accordance with claim 1, wherein messages sent between the terminal device and the server are sent as short messages.

8. A method in accordance with claim 4, wherein the data link comprises a Bluetooth connection.

9. A method in accordance with claim 4, wherein the data link comprises an infrared connection.

10. A method in accordance with claim 5, wherein said encrypting is effected using a public-private key encryption technique.

11. A method in accordance with claim 1, further comprising the step of forming a communication connection between the terminal device and the server using WAP protocol.

12. A method in accordance with claim 1, further comprising the step of forming a communication connection between the terminal device and the server using HTML protocol.

13. A method in accordance with claim 1, wherein messaging communications between the terminal device and the server are effected using MIME-type messages.

14. A system for handling transaction data in a telecommunications network, comprising:
a server;
a terminal device of a requester for forming and sending a transaction request from the terminal device to the server, wherein the transaction request comprises identifying data of the requester, identifying data of a utilized network component and a digital signature of the requester;
means in said server for forming and sending a transaction message in response to receipt by the server of the transaction request;
an adder for appending message-type data and subscriber data to the transaction message before the transaction message is sent by the server;
a filter in the telecommunications network for extracting the message-type data and the subscriber data from the sent transaction message; and
a handling device in the telecommunications network for using the collected message-type data and subscriber data as handling data for a transaction that is the subject of the transaction request.

15. A system in accordance with claim 14, further comprising a collector for collection of the extracted message-type data and subscriber data and for storing the collected message-type data and subscriber data in a billing database.

16. A system in accordance with claim 14, wherein said adder is operative for attaching the message-type data and the subscriber data to a header part of the transaction message.

17. A system in accordance with claim 14, further comprising means for forming a data link between the terminal device and the server.

18. A system in accordance with claim 14, further comprising registration tools in said terminal device for registering the terminal device with the server using a user identity of the terminal device and for notifying the server of a physical network address of one of the terminal device and another device to which the transaction message is to be sent.
